(19) United States
(12) Patent Application Publication
(10) Pub. No.: US 2017/0224094 A1
(43) Pub. Date: Aug. 10, 2017

(54) Paint Brush With Paint Bristle Funnel And Flexible Neck

(71) Applicant: Heinz Welschoff, Fort Lauderdale, FL (US)

(72) Inventor: Heinz Welschoff, Fort Lauderdale, FL (US)

(21) Appl. No.: 15/015,842

(22) Filed: Feb. 4, 2016

(51) Int. Cl. A46B 5/00; B25G 3/36; A46B 3/02

(52) U.S. Cl. CPC A46B 5/0037; A46B 3/02; B25G 3/36

(57) ABSTRACT

A paint brush includes a handle including a base generally defining a solid cylinder, the base further including a proximal region, the handle having an axial hollow channel, the channel having a spiral threaded interior beginning at a proximal end of the channel and ending at a distal end of the handle, the spiral threading proportioned for engagement of a threaded paint pole extension. Beginning at a distal end of the base is a paint brush neck having an integral hollow segment of a flexible accordion-like corrugated material, and the axial channel extending into the neck without threading on it. Disposed distally of the corrugated material and integral with it is an integral bristle support region having a bristle securing recess proportioned for securement of bases of paint brush bristles, the recess including an upper and a lower region, the lower region proportioned for selectable receipt of paint bristles, the bristle-securing recess including an upper and a lower region, the upper region defining mutually slanted planes each in a range of about 20 to about 40 degrees relative to the axial channel, the upper and lower regions defining a funnel for directing excess or splashed paint toward the bristle securing recess.

### FIELD OF THE INVENTION

This invention relates to paint brushes and, more particularly, paint brushes adapted for ease of attachments to paint brush extension poles to, thereby, provide improved methods and apparatus for painting.

### BACKGROUND OF THE INVENTION

Paint brushes are commonly used for applying paints, varnishes, pastes, and films of other viscous materials to various articles. The basic design of most paint brushes has gone unchanged for many years. Paint brushes typically include a plurality of bristles which are bunched together by a collar into a bristle head and attached to a rigid handle having an axis parallel to the bristles.

The above set forth physiologic problems and other difficulties suffered by painters is made worse when the painting surface is at a distance above the height of the painter or the height of the painter even when located upon a paint ladder. As such, the use of so-called paint pole extensions has become common place by those in the painting trades. However, a universal problem is that of securing of the paint brush to the paint brush extension pole, both with security as to the mutual securment, and as to reasonable capability of control of the paint brush relative to the surface to be painted.

The present invention thereby represents an improvement in means of attachments of a painter's brush to brush tool, as opposed to the historic use of mechanical wiring, duck tape, or mechanical clamps to accomplish such attachment.

The prior art also does not offer solutions to painting situations in which there exists objects such as bushes, walls, furniture, etc, which represents impediments to reaching to reaching of surfaces to be painted. Another difficulty with state-of-the art paint brushes, whether used with a paint pole extension or not, is control of dripping or splashing of paint from the bristles of the brush.

The present invention also addresses this need in the prior art.

The present invention also lends itself to storage in a blister pack or the like in order to minimize oxidation of paint left upon the bristles even after the paint brush has been cleaned following a work assignment.

Embodiments of the present invention also facilitate painting of surfaces other that one at a right angle to the paint brush handle, a subject which has always presented difficulty to painters the past.

The present invention is also concerned with the reduction of cost of material of the paint brush and also certain solutions thereto.

Through a novel method of securment of the paint brush bristles within a paint brush holding recess of the head of the paint brush, and splattering of paint away from the brush head and otherwise is considerably reduced.

While numerous references teach the use of a paint bucket or paint bucket accessory which can be used to reduce dripping or splashing from the paint brush there, to the knowledge of the present inventor, does not exist any paint brush which includes an internal construction for the reduction of paint splashing, spillage or the like. See for example. See for example U.S. Patent Application Publication 2008/035650 (2008) to Rittman.

With respect to the prior art of efforts to extend the length or reach of a brush, in combination with a paint brush pole extension, only limited efforts have appeared, such as in U.S. Patent Publication 2002/0066151 (2002) to Parker, entitled Paint Brush With Angle Adjustable Handle and U.S. Pat. No. 8,839,480 (2014) to Thomas, entitled Extend A Brush. While adjustable angles paint brushes are known, no such devices have been adapted for use in combination with paint pole brush extensions.

The present invention addresses this long-felt need in the art.

Paint brushes of this general type are ordinarily used by manually clasping the handle of the brush with the hand and manipulating the brush in a back and forth manner by bending the arm and wrist in a natural fashion. This method generally works well when the surface being worked with the brush is directly in front of and facing the painter. However, when the surface being painted is, for example, above or below the painter and/or facing away from the painter, the bristle head of the brush must be angled to paint such a surface. This is normally accomplished by bending and/or twisting the wrist, arm, and/or shoulder of the hand that manipulates the brush. Unfortunately such manipulations can be very uncomfortable especially during prolonged painting and can even injure the painter's wrist, arm, shoulder, and/or neck.

Accordingly, an improved paint brush is needed which permits the wrist and other parts of the body to be maintained in a more natural attitude while accomplishing more effective painting at various elevations.

### SUMMARY OF THE INVENTION

A paint brush includes (a) a handle including a base defining a substantially solid cylinder, said base further defining a proximal region of said handle, said handle having an axial hollow channel therein, said channel having a spiral threaded interior beginning at a proximal end of said channel, and ending at a distal end of said handle, said spiral threading proportioned for engagement of a threaded paint pole extension; (b) beginning at a distal end of said base, a paint brush neck having an integral segment of a hollow flexible accordion-like corrugated material, and said axial channel extending into said neck without threading thereon; and (c) distally of said corrugated material and integral therewith, bristle support region having a bristle securing recess proportioned for selectable securement of paint brush bristles therein, said bristle-securing recess including an upper and a lower region, said lower region proportioned for receipt of bases of bristles paint therein, said upper region defining inner and outer sides mutually slanted planes in a range of about 20 to 40 degrees relative to said hollow axial channel of the paint brush, said upper and lower regions defining a funnel directing excess or splashed paint toward said bristle securing recess.

It is accordingly an object of the present invention to provide a paint brush with a paint bristle funnel included at the base of the securing recess at the front or bristle support region of the paint brush in which, by virtue of the geometry of the bristle support region, the escape of the paint through splashing, dripping or otherwise from the paint brush head is minimized.

It is a further object to provide a paint brush which can bend about a central axis thereof within a range of plus to minus 45 degrees.

It is a yet further object of the invention to provide a paint brush of the above type in which the use of construction material therefore is minimized through the use of a longitudinal internal channel.

The above and yet other objects and advantages of the present invention will become apparent from the hereinafter set forth Brief Description of the Drawings, Detained Description of the Invention and Claims appended herewith.

### BRIEF DESCRIPTION OF THE DRAWINGS

FIG. 1 is a vertical elevational view of first embodiment of my inventive paint brush prior to insertion of the paint brush bristles thereinto.

FIG. 2 is a bottom plan view of FIG. 1.

FIG. 3 is an elevational view, similar to that of FIG. 1, however including the addition of paint bristles to the system.

FIG. 4 is a vertical cross-sectional view of the view of FIG. 3, as above described.

FIG. 5 is a side diagonal elevational perspective view of the paint brush of FIG. 3.

FIG. 6 is a side elevational view of the brush as shown in FIG. 3.

FIG. 7 is a vertical cross-sectional view of the brush as shown in FIG. 6.

FIG. 8 is a cross-sectional view, similar to that of FIG. 7, however showing the structure prior to insertion of the paint brush bristles thereinto.

FIG. 9 is a perspective view of the structure of FIG. 1, however before the insertion of paint brush bristles into the mouth thereof.

FIG. 10 is an external elevational view of the paintbrush shown in FIG. 8.

FIG. 11 is an elevational, partially assembled view of a paint brush shown in FIGS. 3, 4 and 5.

FIG. 12 is an enlarged view of the flexible neck region of paint brush 100 shown in FIGS. 1-11.

FIG. 13 is a view showing the adjustability of the neck paint brush of embodiment 100 relative to the vertical channel of the base of the brush.

FIG. 14 is a front elevational schematic view of a second embodiment 200 of the inventive paint brush.

FIG. 15 is a side elevational view of the brush shown in FIG. 14.

FIG. 15A is an enlargement of the paint retaining region of the base of the brush bristles shown in FIG. 15.

FIG. 16 is a front elevational view of a third embodiment 300 of the present invention prior to the insertion thereinto of the brush bristles.

FIG. 17 is a bottom plan view of the brush as shown in FIG. 16.

FIG. 18 is a front elevational view similar to that of FIG. 16, however showing inserted thereinto the paint brush bristles.

FIG. 19 is a cross-sectional view of the brush of FIG. 18.

FIG. 20 is a side, diagonal elevational view of the brush of FIG. 18.

FIG. 21 is a side elevational view of the brush of FIG. 20.

FIG. 22 is a vertical cross-sectional view of the brush of FIG. 21.

FIG. 23 is a view, similar to that of FIG. 22, however prior to the insertion of brush bristles into the mouth thereof.

FIG. 24 is a side perspective view of the brush of FIGS. 16 and 17 prior to the insertion of bristles into the mouth thereof.

FIG. 25 is a view, similar to that of FIG. 21, however shown prior to the insertion of brush bristles thereinto.

FIG. 26 is a view of a third embodiment 300, related to that of FIG. 11 of embodiment 100, in which the preferred method of attachment of the brush bristles to the mouth of the brush is shown.

FIG. 27 is a top plan view of the embodiment of FIG. 26.

FIG. 28 is a vertical cross-sectional view of the brush 300 as shown in FIG. 26.

FIG. 29 is an integrated top and front elevational view of the brush of FIG. 26.

FIG. 30 is an integrated view showing the vertical cross-section of the brush of FIG. 29, a top view thereof and separate sub-views of the brushes thereof provided with glue tape about the base thereof.

FIG. 31 is a vertical elevational view of a fourth embodiment 400 of the inventive paint brush showing therein a flexible neck as well as a specially designed paint brush base funnel adapted to minimize splashing, dripping and loss of paint in general.

FIG. 32 is a side elevational view of the brush of FIG. 31.

FIG. 33 is a perspective view of the embodiment of FIGS. 31-33 in which the neck thereof has not been bent.

FIG. 34 is a perspective view of the embodiment of FIGS. 31-33 in which the flexible neck thereof is bent to an angle of about 45° relative to the central channel of the base and neck of the brush.

FIG. 35 is a view of the reverse side of the brush shown in FIG. 33.

FIG. 36 is a vertical cross-sectional view of the brush of FIG. 31.

FIG. 37 illustrates the complemental geometry of the end of flexible element of an extension pole adapted to mate with the base of the brush.

FIG. 38 is a side cross-sectional elevational view of FIG. 36.

FIG. 39 is a view showing the adjustability of the flexible element of the lower portion of FIG. 37.

### DETAILED DESCRIPTION OF THE INVENTION

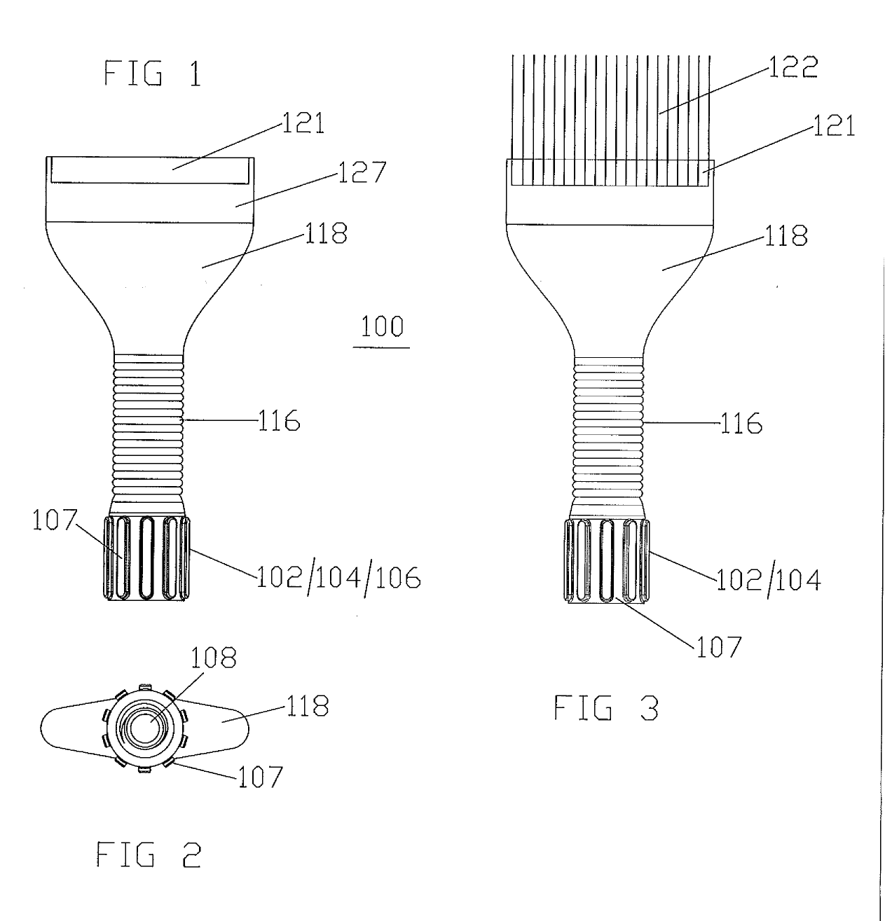

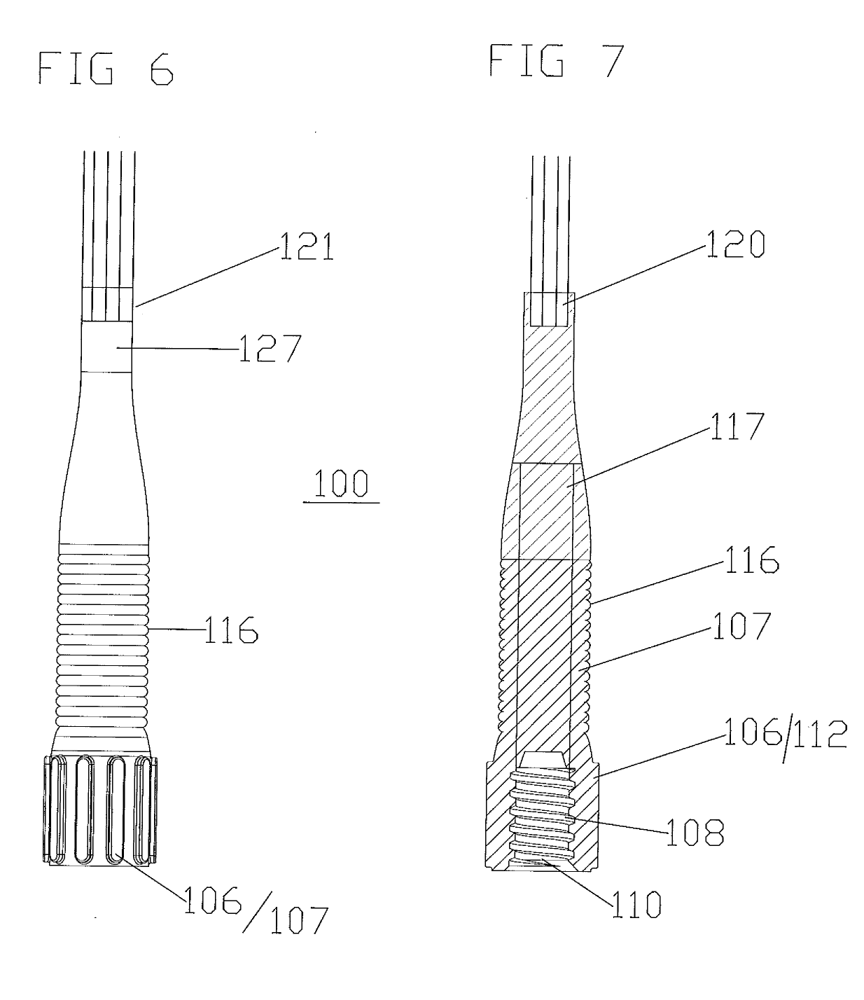

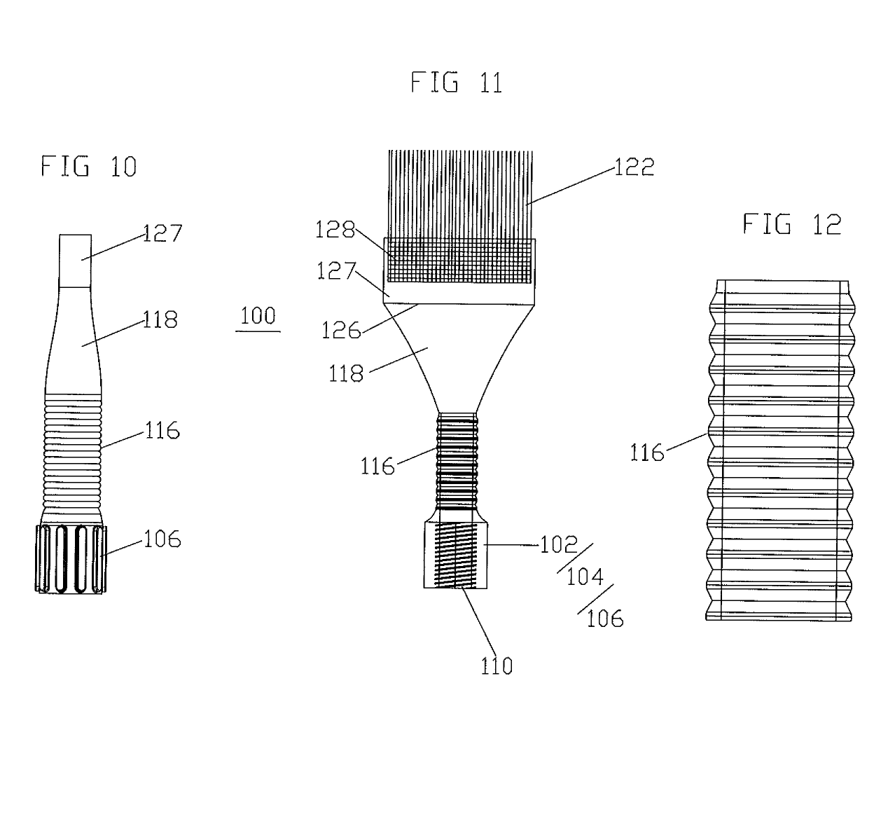

With reference to FIGS. 1-12, there is shown a first embodiment of the present inventive paint brush 100. Starting from the bottom or proximal end thereof, said paint brush 100 includes a handle 102 having a base 104 which substantially defines a solid cylinder 106. As may be noted in the figures, said base 104 is characterized by an axial hollow channel 108 therein (see FIGS. 2, 5, 4, 5, 7 and 8), in which said axial hollow channel 108 exhibits a spiral-threaded interior beginning at a proximal end 110 of the channel 108 and ending at a distal end 112 of said threaded channel 108. Spiral threading of channel 108 is proportioned for engagement of a threaded paint pole extension 130 as is shown in FIG. 14. In all the embodiments of the present invention, it is to be appreciated that said spiral threaded channel 108 is proportioned for engagement of a threaded paint pole extension, as is more fully explained below.

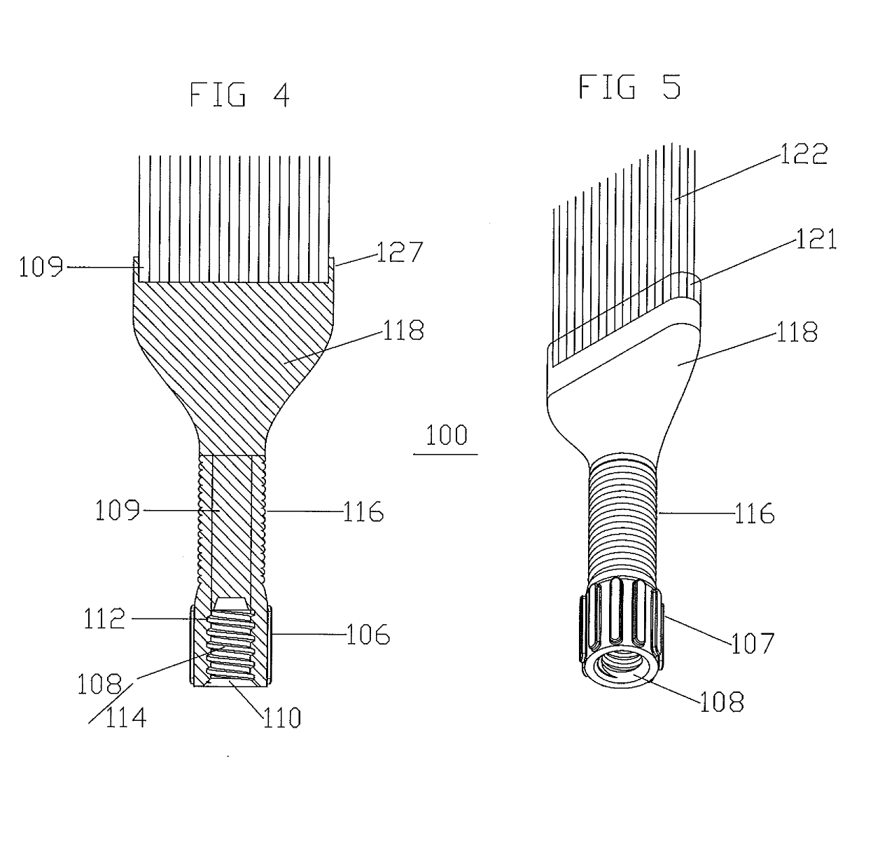

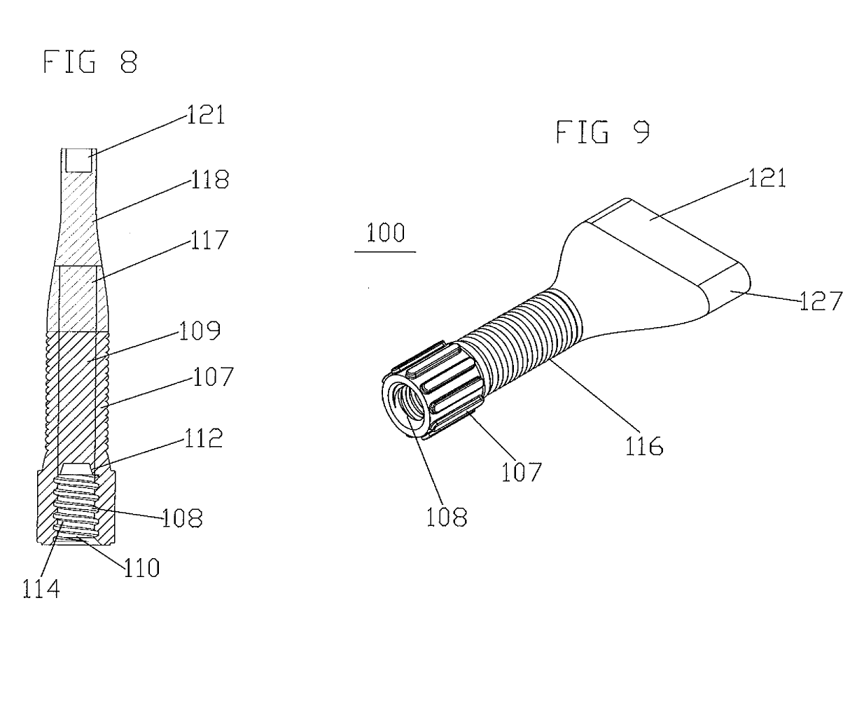

Beginning at a distal end 112 of said base 104 is a paint brush neck 116 which may be formed of a hollow corrugated material and possesses an axial channel 109 (see FIGS. 4 and 8) extending into said neck 116 but without threading therein.

Distally of corrugated tubing 116 but integral therewith is a bristle support region 118 having a bristle securing recess 127 proportioned for selectable securement of groups of paint brush bristles 122 therein. As may be seen in FIGS. 1-10, the bristle support region 118 is disposed at the distal end of the paint brush neck 116 in which is formed bristle securing recess 127 which wraps about a proximal end of region 118 below recess mouth 121 of bristle securing recess 127 of paint brush 100 to define the bristle receiving mouth 121, more fully described below.

In FIG. 7, it is to be noted that axial channel 109 of paint brush neck 116 preferably extends into channel 117 of the lower portion of bristle support region 118 to conserve upon the use of materials. This channel may be seen as viewed as an extension of channel 109. See FIGS. 7 and 8. The process of inserting and securing bristles 122 within bristle support region 118 is shown in the views of FIGS. 3 thru 11. More particularly, in the view of FIG. 12, bristles 122 possess a length of about 40 millimeters however the lower approximately 15 millimeters (37.5%) of the bristles are secured in the position shown in FIG. 11 through the use of a combination of porous strip of tape 128 and appropriate glue applied thereto during the production process. As may be seen in FIGS. 3 to 5 and 7, after the bristles are secured by tape 128 and glue (not shown) their insertion into bristle securing recess 127 and porous strip 128 obviate the need for a circumferential band of a metallic material which characterizes almost all prior art brushes of this type.

A cross-section of the brush of FIGS. 3 and 5 is shown in FIG. 4. As may therefore be appreciated, the only materials required in the construction of the present paint brush 100 are an appropriate plastic polymer such as a high density polyethylene, appropriate synthetic or natural bristles such as a polyester or animal hair, and an appropriate bonding agent for securing the lower portion of the bristles into bristle securing securing recess 127 and to bonding strip 128. Thereby the need for any metallic strip surrounding the bottom of the bristles or a bristle cartridge does not exist in any embodiment of this invention.

As may be noted in a comparison in the view of FIG. 4 with that of FIG. 11, one is afforded considerable flexibility in the appearance of the brush 100 provided there is uniformity of mass of material at the distal end 120 of the bristle support region 118.

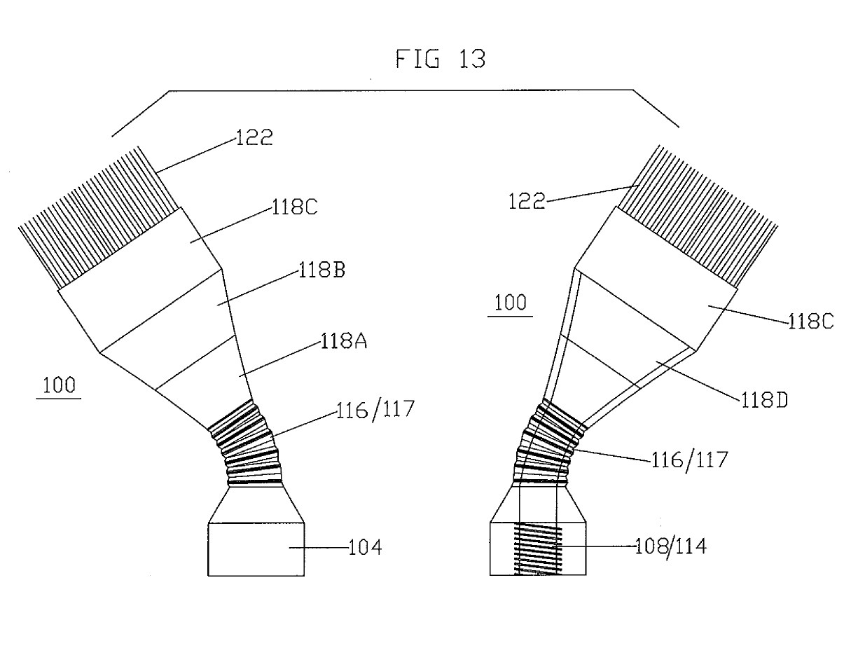

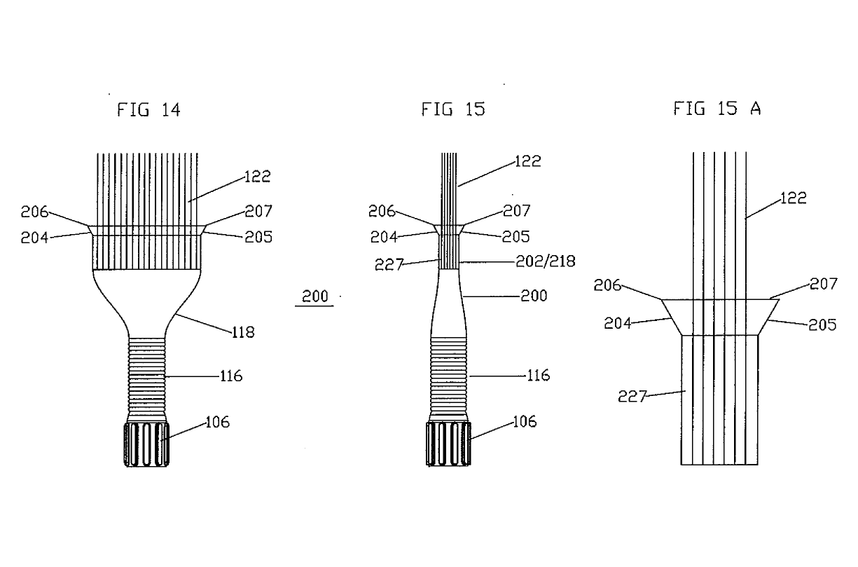

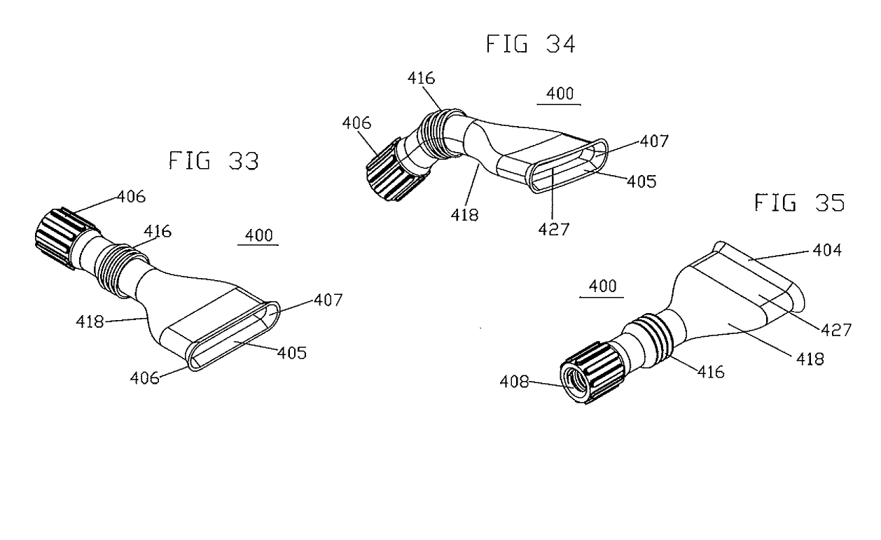

In FIG. 12 is shown an enlarged cross-sectional view of the center of FIG. 11 by which may be more particularly seen the structure of the memory retentive elements 117 of the corrugated neck 116 of the brush. The corrugated material of segment 116 must possess particular properties for the instant invention, namely, said corrugations must define memory-retentive angulations which, in aggregate, must total at least plus or minus 45° degrees from the axis of said axial channel 108 of the paint handle 104, this as is illustrated in FIG. 13. In other words, while segments of corrugated neck 116 must be memory retentive sufficient for purposes of a given assignment. When the assignment is completed, said segments must permit manual return to their normal linear position as is shown in FIGS. 1-11. It has been found that a polymer of suitable properties for this application includes said high density polyethylene and that the 45° angular displacement may be attained with as few as three rings having relative angulation of 15° each relative to channel 108. See also FIGS. 33-35.

Further shown in FIG. 13 are variations in the bristle support region 118 which are within the scope of the embodiment 100 of the invention. For example, to the left of FIG. 13 are shown segments 118A, 1188, and 118C. Such an arrangement provides a greater degree of flexibility in positioning of bristles 122 relative to base 104, thereby limiting the range of memory retention required of each corrugated element 117, this simplifying the design parameters of the system.

To the right of FIG. 13 is shown an alternative geometry for the bristle support region having portions 118C and 118D which also provides greater system flexibility, thereby reducing the necessary range of memory retention of the elements 117 of the paint brush neck 116.

All versions of paint brush 100 may be provided with a knurled circumferential base 107 as may be seen in FIGS. 1 through 10. Such a knurled surface is useful in securing the inventive paint brush to the paint brush extension pole to which it is secured. Also, through the use of a wrench, paint brush 100 may be particularly firmly secured to the extension pole if the knurled base is used.

Shown in FIG. 14 is a variation of the bristle support region 218 of a further embodiment of the inventive paint brush 200. Said paint brush 200 differs from prior art bristle securing systems in the manner particularly shown in FIGS. 14 and 15. Therefrom one may see that while lower portions 202/218 of the bristle securing recess 218 are generally similar to that in the embodiment of FIGS. 1-13. However, there is further provided an effective funnel by the action of surfaces 204/205 and edges 206/207, the effect of which is to minimize the splashing, spilling or escape of paint from bristles 122 to thereby return such excess paint to reservoir region 227 of the system. Accordingly, in addition to the various other advantages above described, the embodiment of paint brush 200 offers the additional benefit of substantially reducing the dripping and other loss of paint that occurs in prior art paint brushes. This feature is particularly important where the paint brush is elevated at the end of a long pole, such that the consequences of paint which escapes from funnel 208 (see FIG. 15A) is a large amount of splatter and thereby attendant clean-up of the worksite after the painting has been completed. Also, the feature of FIGS. 14, 15 and 15A will reduce the amendment of cleaning of the bristles of the brush necessary after completion of a particular task.

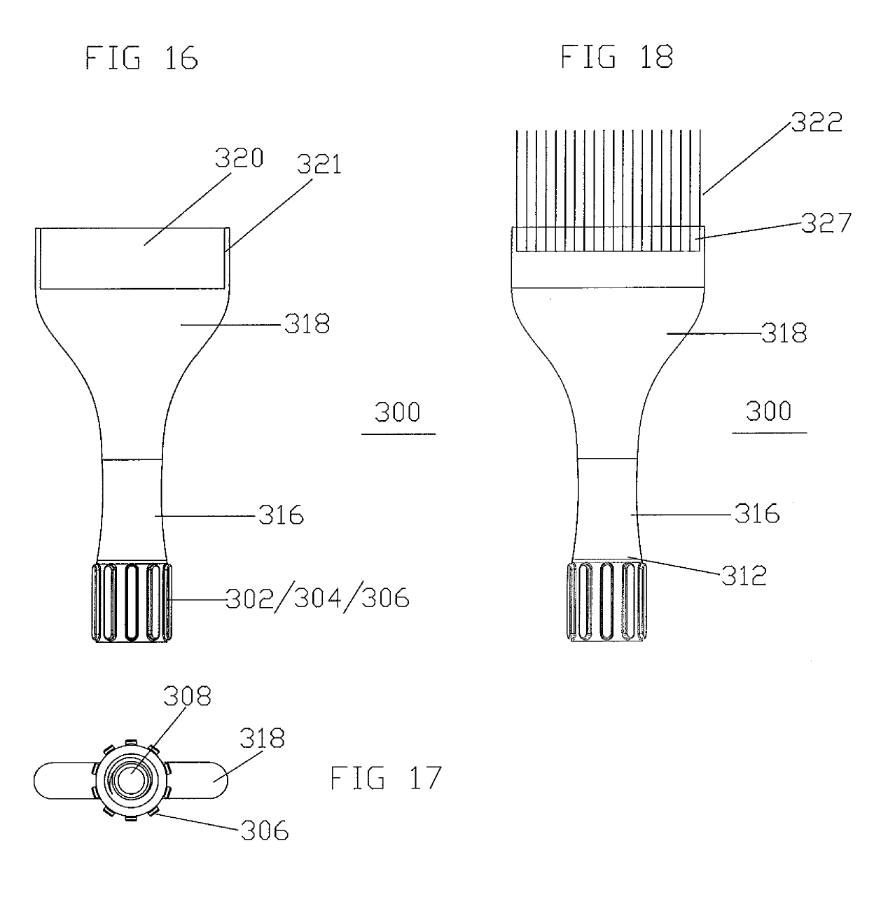

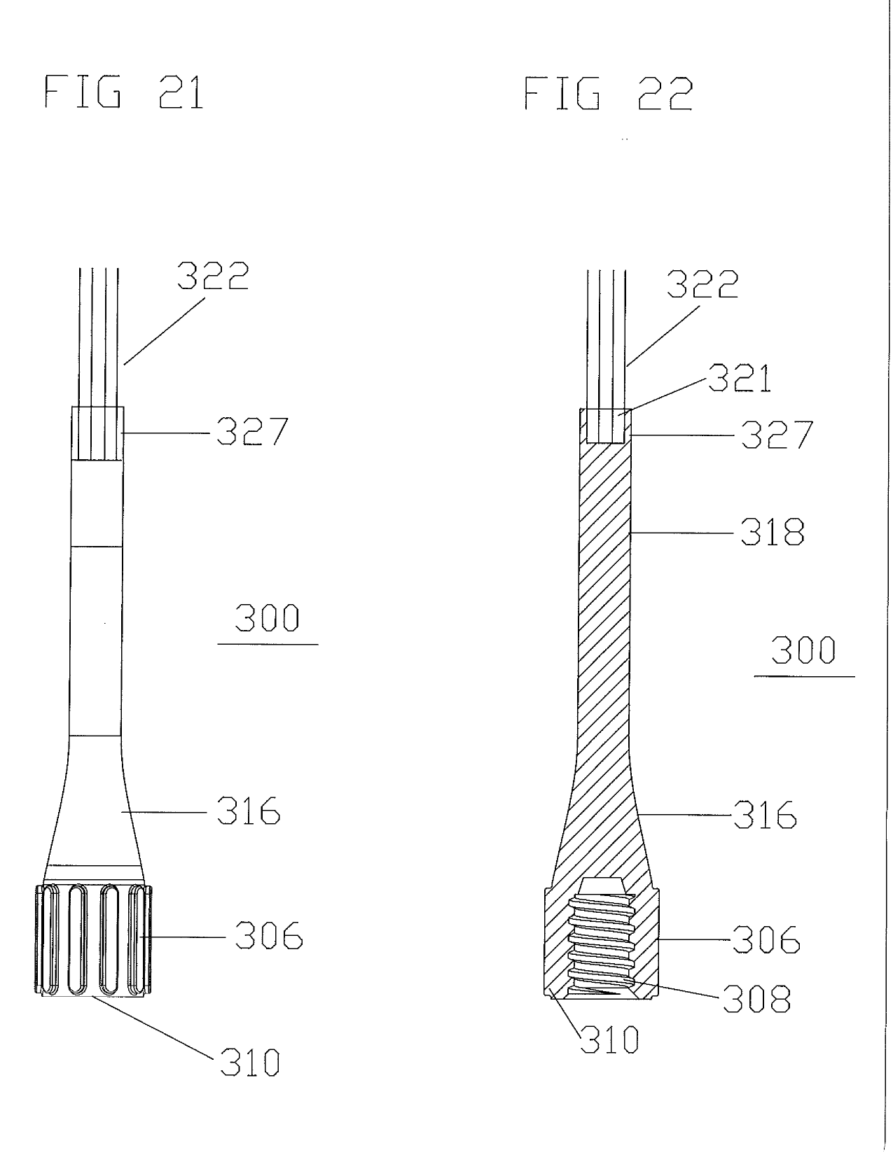

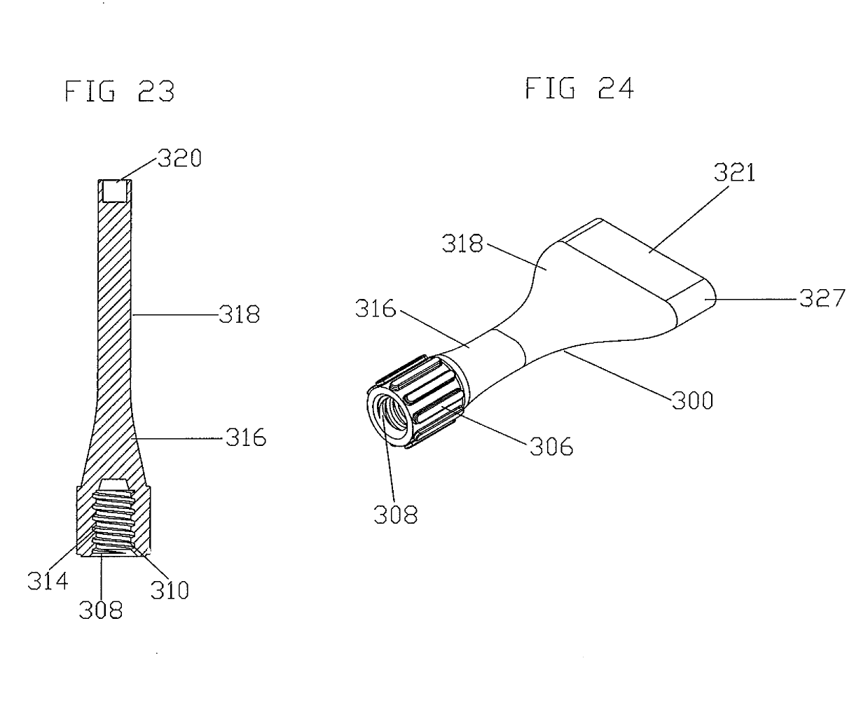

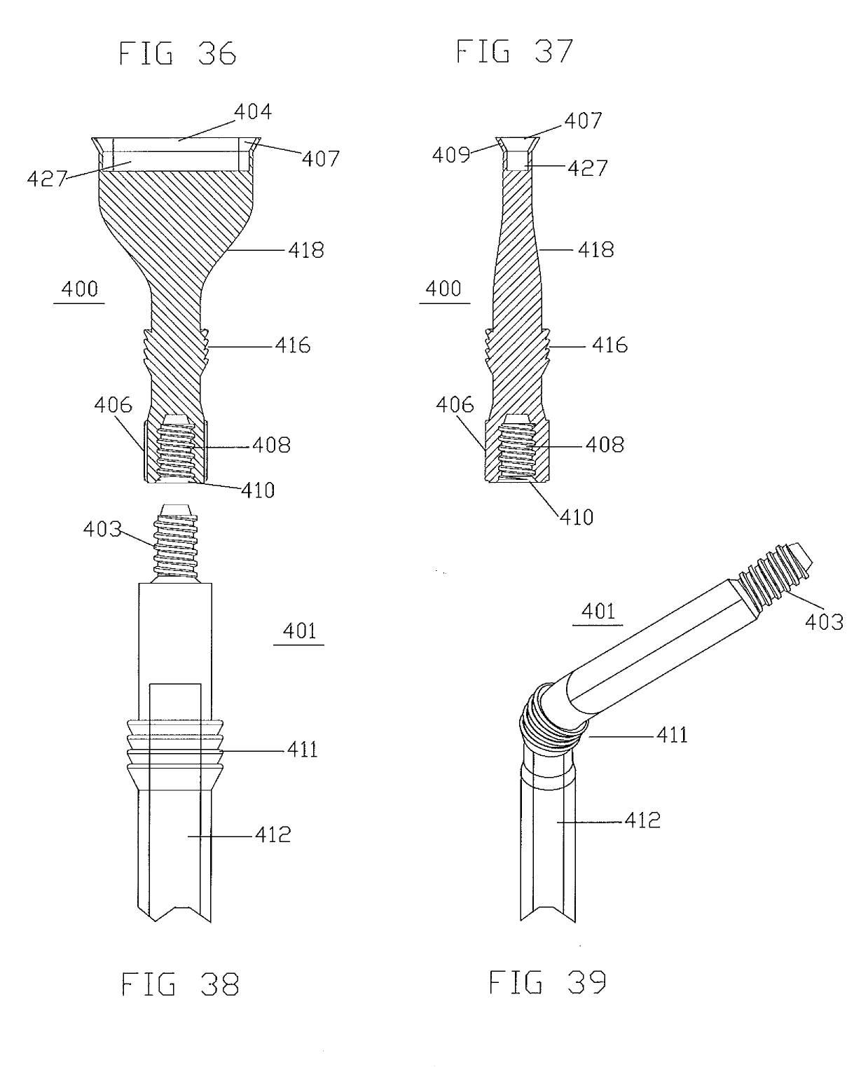

With reference to FIGS. 16-30, there is shown a third embodiment of the inventive paint brush 300. Starting at the bottom or proximal end thereof, said paint brush 300 includes a handle 302 having a base 304 which defines a substantially solid cylinder 306. As may be noted in said figures, the base 304 is characterized by an axial hollow channel 308 therein (see FIGS. 20 to 30) in which said hollow axial channel exhibits a spiral threaded interior 308 beginning at a proximal end 310 of the channel 308 and ending at a distal end 312 of the threaded channel 308. Spiral threading of channel 308 is proportioned for engagement of a threaded paint pole extension as is shown in FIG. 36. In most embodiments of the instant invention, it is to be appreciated that spiral threaded channel 308 is proportioned for engagement of threaded paint pole extension, the only exception being where the paint brush is used as a regular paint brush.

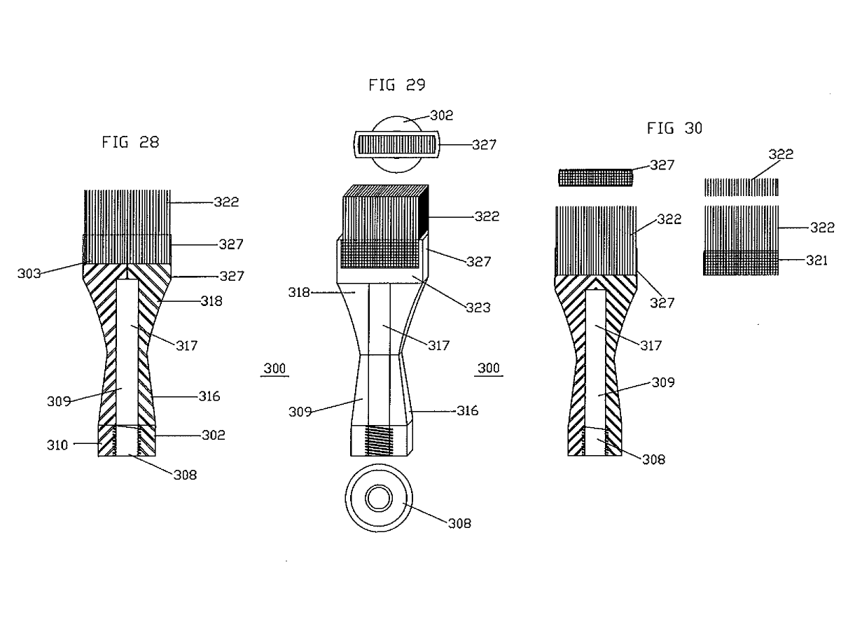

Beginning at distal end 312 of said base 304 is a paint brush neck 316 which is formed of a hollow corrugated material and possesses an axial channel 309 (see FIGS. 26 and 28), extending into said neck 316 but without threading upon channel 309.

Distally of neck 316 but integral with bristle support region 318 is a bristle securing recess 327 propositioned for securement of paint brush bristles 312. As may be seen in FIGS. 18-30, the bristle securing recess 327 is disposed at a mouth 321 formed within bristle securing recess 327. In other words, bristle securing recess 327 defines a mouth 321 with glue tape to define a rigid bristle securing mouth 321, as more fully described below.

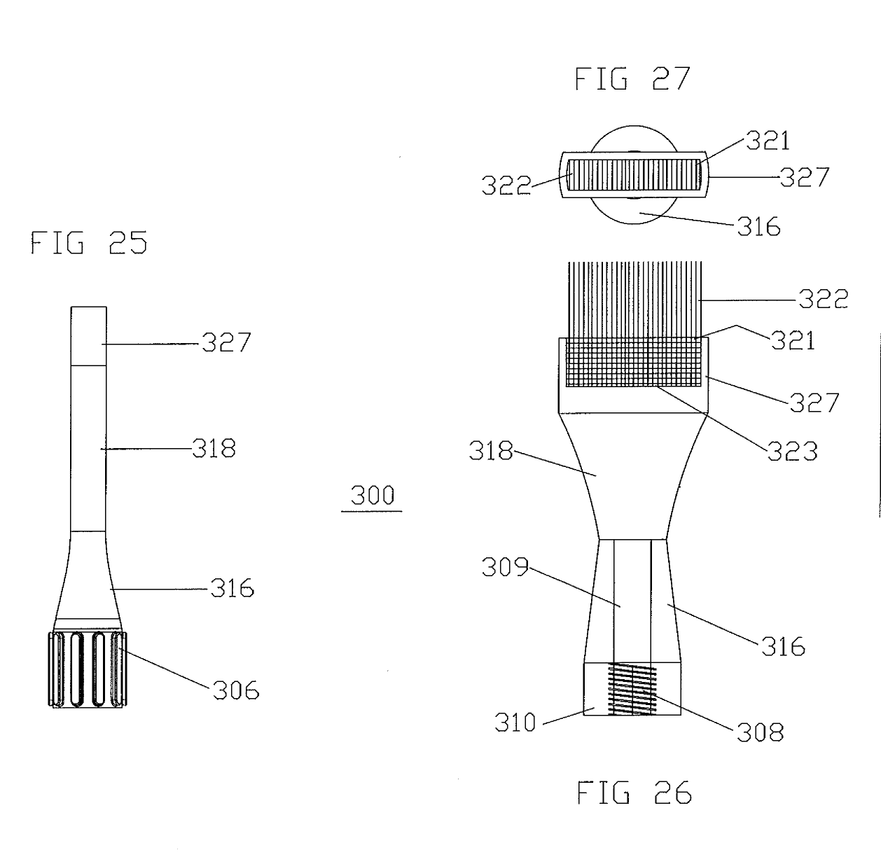

It is to be appreciated that axial channel 317 (see FIGS. 26-30) of the paint brush neck 316 preferably extends into the lower portion of bristle support region 318 in the manner shown in FIG. 8, to thereby conserve the use of materials, whether natural or synthetic. This may be viewed as an extension of the channel 309 shown in FIGS. 26 to 30. The process of inserting and securing bristles 322 within bristle support region 318 is shown in the views of FIGS. 18 thru 26. More particularly, in the view of FIG. 27, bristles 322 possess, as in the embodiment of paintbrush 100, a length of about 40 millimeters in which about 15 millimeters thereof are secured in the manner shown in FIG. 27. Thereby, in a range of 30 to 40 percent of the bristles are bonded within bristle support region 317.

As is shown in FIGS. 5 and 11 of the embodiment of brush 100, after the bristles are secured by glue tape 328 and glue (not shown) a cosmetic surface strap of material may be added. As such (see FIG. 26) bristle securing recess 327 and physical gluing strip 328 obviate the need for a circumferential band of a metal or metallic material which characterizes almost all prior art brushes. As such, costly metal, assembly of such metha and its fastening materials such as nails or staples are not needed.

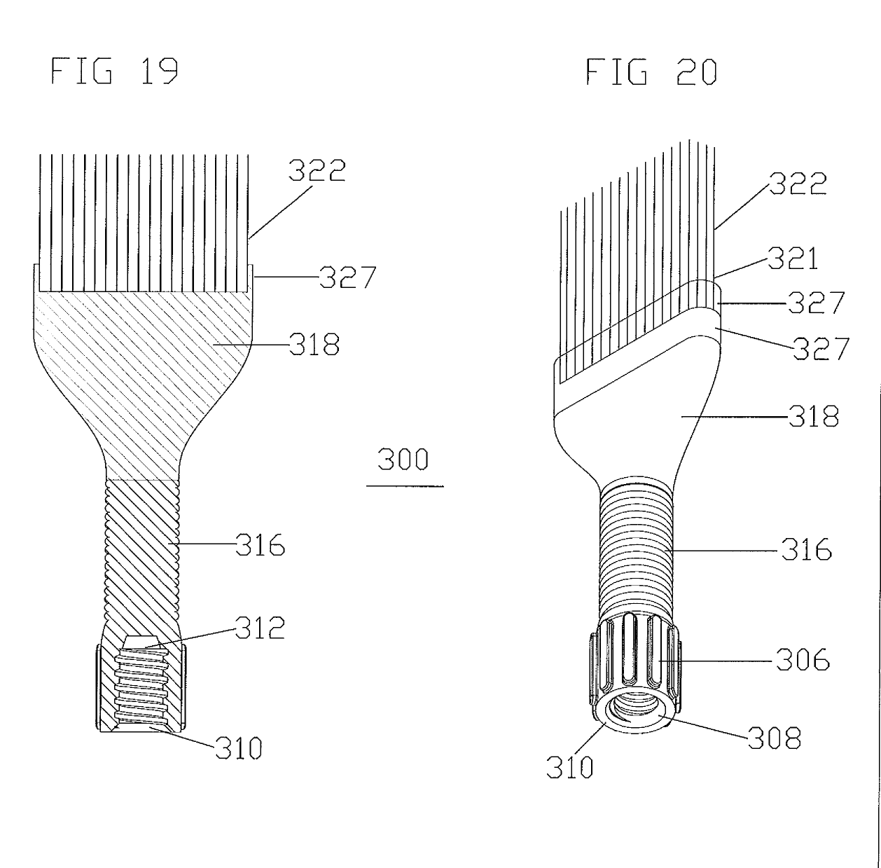

A cross-section of the brush of FIG. 18 is shown in FIG. 19. As may be appreciated, the only materials required for the construction of paint brush 300 are that of an appropriate plastic polymer such as high density polyethylene or polycarbonate, appropriate synthetic bristles made of material such as polyester or animal hair, and appropriate bonding agent for securing of the lower portion of the bristles into the bristle securing recess 327 and the use of an appropriate bonding strip 321 (see FIGS. 15, 26-30).

As above noted, paint brush 300 may be provided with a knurled base 306 as may be seen in FIGS. 16-25. Such a knurled surface is useful in securing the inventive brush 300 to a paint brush extension pole to which it is secured. That is, through the use of a wrench, brush 300 may be more firmly secured to such an extension pole.

Shown in FIG. 27 is a version of brush 300 corresponding to that shown in FIG. 11 for brush 100.

Shown in FIGS. 28 to 30 is a further variation of brush 300 in which the brush is provided with a more geometric appearance.

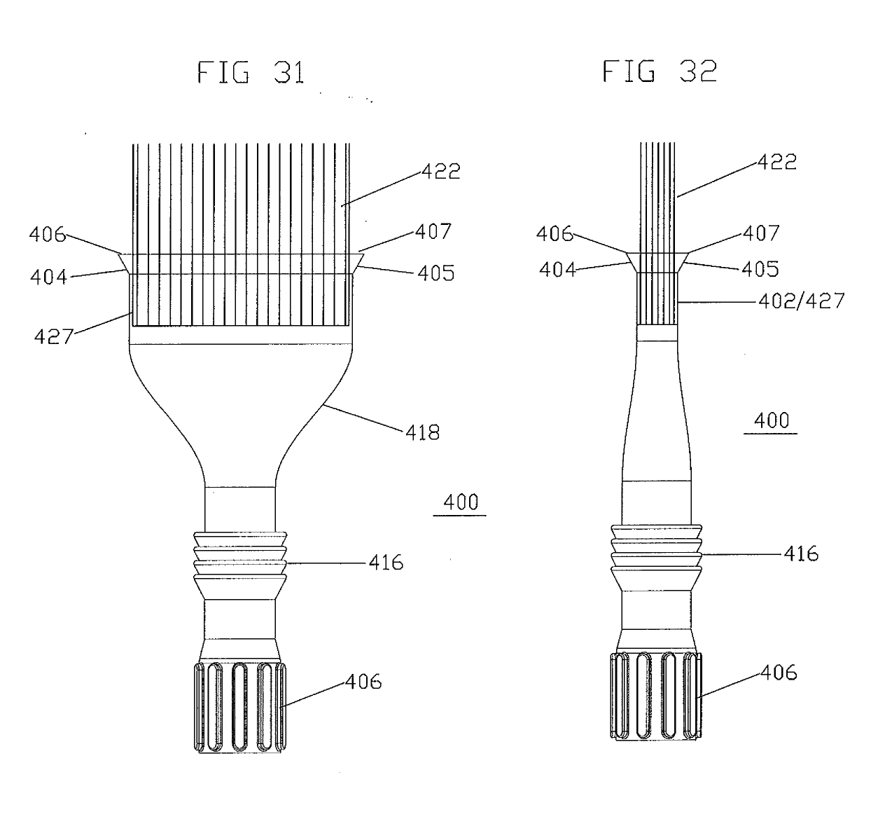

Shown in FIG. 31-37 is an embodiment 400 corresponding to the above-described embodiment 200 of the present invention, in which there is similarly provided a funnel structure about the bristle securing recess 427, the structure and function of which correspond to that above shown and described with reference to FIGS. 14 to 15A of the above embodiment 200 of the inventive system. Perspective views of paint brush 400 are shown in FIGS. 33-35, the same showing opposing surfaces 404 and 405 which, relative to the axis of channel 408, define an opposing angulation in a range of 20 to 40 degrees. See FIG. 15A. FIGS. 33-34 also show that neck 416 may comprise as few as three rings, each having a 15 degree maximum angulation, such that three rings can produce a neck angle of up to 45 degrees.

FIG. 36 is similar to FIG. 31 but without the bristles installed therein.

FIG. 37 shows an extension pole 401 from which depends spiral male element 403 which mates with spiral recess 408 of base 406 of brush 400. In a preferred embodiment, pole 400 is provided with a longitudinal channel 403 which extends past a group of flexible elements 411 similar to flexible elements 416 at the neck of brush 400. As a result of this system, the painter is provided with a flexible brush as well as a flexible extension pole, a result of which is that many more possible angulations of the brush bristles relative to both the brush handle 406 and the extension pole 401 may be reached. As is well known to painters, there exist many difficult-to-reach painting surfaces that can be more effectively reached by the brush and pole system of FIGS. 36-39

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. A paint brush, comprising:
(a) a handle including a base defining a substantially solid cylinder, said base further defining a proximal region of said handle, said handle having an axial hollow channel therein, said channel having a spiral threaded interior beginning at a proximal end of said channel, and ending at a distal end of said handle, said spiral threading proportioned for engagement of a threaded paint pole extension;
(b) beginning at a distal end of said base, a paint brush neck having an hollow integral segment of a flexible accordion-like corrugated material, and said axial channel extending into said neck without threading thereon; and
(c) distally of said corrugated material and integral therewith, an integral bristle support region having a bristle securing recess proportioned for selectable securement of paint brush bristles therein.

2. The paint brush as recited in claim 1, in which a longitudinal length of said corrugated segment defines a length generally equal to that of said bristles when secured within said recess.

3. The paint brush as recited in claim 1, in which a distal segment of said channel of said neck extends into a portion of said bristle support region.

4. The paint brush as recited in claim 1, said corrugated material defining memory-retentive angulations totaling at least plus or minus 45° degrees relative to an axis said channel of the paint brush.

5. The paint brush as recited in claim 3, said handle having a gnarled external surface thereof.

6. The paint brush as recited in claim 3, in which said selectable securement of said bristles into said bristle securing recess includes a pressure fit securement.

7. The paint brush as recited in claim 3, in which said selectable securement of said bristles into said bristle securing recess includes a glue-implemented securement.

8. The paint brush as recited in claim 6, further including a perforated tape secured about said base of said bristles before glue is applied thereto.

9. The paint brush as recited in claim 1, in which said bristle-securing recess includes an upper and a lower region, said lower region proportioned for receipt of bases of paint bristles therein, said upper region defining inner and outer mutually slanted planes in a range of about 20 to about 40 degrees relative to said hollow axial channel of the paint brush, said upper and lower regions defining a funnel directing excess or splashed paint toward said bristle securing recess.

10. The paint brush as recited in claim 3, in which said bristle-securing recess includes an upper and a lower region, said lower region proportioned for selectable receipt of paint brushes therein, said upper region defining inner and outer mutually slanted planes in a range of about 20 to about 40 degrees relative to said hollow axial channel of the paint brush, said upper and lower regions defining a funnel directing excess or splashed paint toward said bristle securing recess.

11. The paint brush as recited in claim 8, in which a length of bristles secured within said bristle securing recess to an entire bristle length, defines a range of between about 30 and about 40 percent.

12. A paint brush, comprising:
(a) a handle including a base defining a substantially solid cylinder, said base further defining a proximal region of said handle, said handle having an axial hollow channel therein, said channel having a spiral threaded interior beginning at a proximal end of said channel, and ending at a distal end of said handle, said spiral threading proportioned for engagement of an end of a threaded paint pole extension;
(b) beginning at a distal end of said base, a paint brush neck having an integral segment of a hollow flexible accordion-like corrugated material, and said axial channel extending into said neck without threading thereon; and
(c) distally of said corrugated material and integral therewith, an integral bristle support region having a bristle securing recess proportioned for selectable securement of paint brush bristles therein, said bristle-securing recess including an upper and a lower region, said lower region proportioned for receipt of bases of bristles paint therein, said upper region defining inner and outer mutually slanted planes in a range of about 20 to about 40 degrees relative to said hollow axial channel of the paint brush, said upper and lower regions defining a funnel directing excess or splashed paint toward said bristle securing recess

13. A paint brush, comprising:
(a) a handle including a base defining a substantially solid cylinder, said base further defining a proximal region of said handle, said handle having an axial hollow channel therein, said channel having a spiral threaded interior beginning at a proximal end of said handle, and ending at a distal end of said channel; said spiral threading proportioned for engagement of an end of a threaded paint pole extension;
(b) beginning at a distal end of said base, an integral hollow segment defining a neck of the paint brush beginning at a distal end of said base, and said axial channel of said handle extending into said neck without threading thereon; and
(c) distally of said corrugated material and integral therewith, a bristle support region having a bristle securing recess proportioned for selectable securement of paint brush bristles therein.

14. The paint brush as recited in claim 12, in which a longitudinal length of said neck defines a length generally equal to that of said bristles before secured within said recess.

15. The paint brush as recited in claim 12, in which a distal segment of said unthreaded portion of said channel extends into a portion of said bristle support region.

16. The paint brush as recited in claim 14, said handle having a gnarled external surface thereof.

17. The paint brush as recited in claim 14, in which securement of said bristles into said bristle securing recess includes a pressure fit securement.

18. The paint brush as recited in claim 16, in which said bristle-securing recess includes an upper and a lower region, said lower region proportioned for selectable receipt of paint brushes bristles therein, said upper region defining inner and outer sides of the bristle securing recess defined by mutually slanted planes in a range of about 20 to about 40 degrees relative to said hollow axial channel of the paint brush, said upper and lower regions defining a funnel directing excess or splashed into said lower region thereof.

19. The paint brush as recited in claim 12, in which said bristle-securing recess includes an upper and a lower region, said lower region proportioned for selectable receipt of paint brushes therein, said upper region defined by mutually slanted planes in a range of about 20 to about 40 degrees relative to said hollow axial channel of the paint brush, said upper and lower regions defining a funnel directing excess or splashed paint toward said bristles securing recess.

20. A paint brush, comprising:
(a) a handle including a base defining a substantially solid cylinder, said base further defining a proximal region of said handle, said handle having an axial hollow channel therein, said channel having a spiral threaded interior beginning at a proximal end of said channel, and ending at a distal end of said handle, said spiral threading proportioned for engagement of a threaded paint pole extension;
(b) beginning at a distal end of said base, a paint brush neck having an hollow integral segment of a flexible accordion-like corrugated material, and said axial channel extending into said neck without threading thereon; and
(c) distally of said corrugated material and integral therewith, an integral bristle support region having a bristle securing recess proportioned for securement of bases of paint brush bristles therein, said bristle-securing recess including an upper and a lower region, said lower region proportioned for selectable receipt of paint bristles, said bristle-securing recess including an upper and a lower region, said upper region defining mutually slanted planes in a range of about 20 to about 40 degrees relative to said axial channel of the paint brush, said upper and lower regions defining a funnel directing excess or splashed paint toward said bristle securing recess.

21. A paint brush extension pole, comprising:
(a) a rigid elongate member having a longitudinal channel within a portion thereof, inclusive of a distal end of the member; and
(b) A plurality of flexible circumferential rings disposed about a surface of said pole and upon a portion of said pole including said channel.
